(19) United States
(12) Patent Application Publication
(10) Pub. No.: US 2018/0275845 A1
(43) Pub. Date: Sep. 27, 2018

(54) Dashboard Creation With Popular Patterns and Suggestions Using Analytics

(71) Applicant: International Business Machines Corporation, Armonk, NY (US)

(72) Inventors: Laquicia S. Barbee, Durham, NC (US); Kenneth J. Parzygnat, Apex, NC (US); Shikha Srivastava, Cary, NC (US)

(21) Appl. No.: 15/467,012

(22) Filed: Mar. 23, 2017

(51) Int. Cl. G06F 3/0484; G06F 3/0482

(52) U.S. Cl. CPC G06F 3/0484; G06F 3/0482

(57) ABSTRACT

A mechanism is provided for use with dashboards that show computer operations and/or status. The mechanism receives first user dashboard preference data indicative of a first user's historical preferences for dashboard content, layout and/or customizability. The mechanism receives a new dashboard request indicative of a need to design dashboard content and layout for a new dashboard for the first user. Responsive to the new dashboard request, machine logic designs a new dashboard data set corresponding to the new dashboard for the first user based, at least in part, upon the first user dashboard preference data.

### BACKGROUND

The present application relates generally to an improved data processing apparatus and method and more specifically to mechanisms for user interface dashboard creation with popular patterns and suggestions using analytics.

Cloud computing is a type of Internet-based computing that provides shared computer processing resources and data to computers and other devices on demand. It is a model for enabling ubiquitous, on-demand access to a shared pool of configurable computing resources (e.g., computer networks, servers, storage, applications, and services), which can be rapidly provisioned and released with minimal management effort. Cloud computing and storage solutions provide users and enterprises with various capabilities to store and process their data in third-party data centers that may be located far from the user-ranging in distance from across a city to across the world. Cloud computing relies on sharing of resources to achieve coherence and economy of scale.

Though service-oriented architecture advocates “everything as a service” (with the acronyms EaaS or XaaS or simply aas), cloud-computing providers offer their “services” according to different models, of which the three standard models per the National Institute of Standards and Technology (NIST) are Infrastructure-as-a-Service (IaaS), Platform-as-a-Service (PaaS), and Software-as-a-Service (SaaS). These models offer increasing abstraction; they are thus often portrayed as layers in a stack: infrastructure-, platform- and software-as-a-service, but these need not be related. For example, one can provide SaaS implemented on physical machines (bare metal), without using underlying PaaS or IaaS layers, and conversely one can run a program on IaaS and access it directly, without wrapping it as SaaS.

The NIST's definition of cloud computing defines the service models as follows:

Software as a Service (SaaS). The capability provided to the consumer is to use the provider's applications running on a cloud infrastructure. The applications are accessible from various client devices through either a thin client interface, such as a web browser (e.g., web-based email), or a program interface. The consumer does not manage or control the underlying cloud infrastructure including network, servers, operating systems, or storage, or even individual application capabilities, with the possible exception of limited user-specific application configuration settings.

Platform as a Service (PaaS). The capability provided to the consumer is to deploy onto the cloud infrastructure consumer-created or acquired applications created using programming languages, libraries, services, and tools supported by the provider. The consumer does not manage or control the underlying cloud infrastructure including network, servers, operating systems, or storage, but has control over the deployed applications and possibly configuration settings for the application-hosting environment.

Infrastructure as a Service (IaaS). The capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, and deployed applications; and possibly limited control of select networking components (e.g., host firewalls).

In management information systems, a “dashboard” provides at-a-glance views of key performance indicators relevant to a particular objective or business process (e.g., sales, marketing, human resources, or production). Often, the “dashboard” is displayed on a web page or other user interface that is linked to a database that allows the report to be constantly updated. For example, a manufacturing dashboard may show numbers related to productivity such as number of parts manufactured or number of failed quality inspections per hour. Similarly, a human resources dashboard may show numbers related to staff recruitment, retention and composition, for example number of open positions, or average days or cost per recruitment.

Dashboards are often designed to include configurable user preferences. Conventionally such preferences typically include: (i) which operational parameters to display on the dashboard display(s); (ii) the level of granularity at which the operational parameter values should be shown; (iii) units (for example, feet, meters, cubits) used as a basis for displaying a given operational parameter; (iv) display colors; (v) relative sizes at which to display information for various operational parameters (for example, a window relating operational speed might be displayed at twice the area of another dashboard window communicating available operational memory); (vi) threshold highlighting designed to accentuate when an operational parameter requires attention; (vii) orientation of the display of operational parameter view; it may be common for a certain view to appear above or to the left of another view (for example, a tree view of resources typically appears on the left and details about select resources on the right); (viii) display representation type (for example, line chart vs bar chart vs pie chart); (ix) layout of the individual views (for example, placement of legend, number of axes, and styles such as dotted lines, stacked charts, etc.; (x) time period over which to display the history of operational parameters (for example, the last hour, the last day, the last month, etc.); (xi) rates at which to refresh the view with new data (for example, every second, every minute, every 10 minutes, etc.); (xii) labels of various components of the display (for example, legend labels, view titles).

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided for use with dashboards that show computer operations and/or status. The method comprises receiving first user dashboard preference data indicative of a first user's historical preferences for dashboard content, layout and/or customizability. The method further comprises receiving a new dashboard request indicative of a need to design dashboard content and layout for a new dashboard for the first user. The method further comprises, responsive to the new dashboard request, designing, by machine logic, a new dashboard data set corresponding to the new dashboard for the first user based, at least in part, upon the first user dashboard preference data.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a cloud computing node according to an illustrative embodiment;

FIG. 2 depicts a cloud computing environment according an illustrative embodiment;

FIG. 3 depicts abstraction model layers according to an illustrative embodiment;

FIG. 4 is a block diagram of a dashboard creation tool in accordance with an illustrative embodiment;

FIG. 5 is a block diagram of a dashboard creation tool for creating dashboards with popular patterns and suggestions using analytics in accordance with an illustrative embodiment;

FIG. 6 depicts an example dashboard of widgets in accordance with an illustrative embodiment;

FIG. 7 is a flowchart illustrating operation of a dashboard creation tool in accordance with an illustrative embodiment; and

FIG. 8 is a flowchart illustrating a dashboard creation tool for creating dashboards with popular patterns and suggestions using analytics in accordance with an illustrative embodiment.

### DETAILED DESCRIPTION

Dashboards often provide at-a-glance views of key performance indicators relevant to a particular objective or business process. Dashboards provide a layout of software widgets, which are relatively simple and easy-to-use software graphical control elements. These graphical user interface (GUI) widgets are examples of reusable modular components that are used together to build a more complex application, allowing administrators to build user interfaces by combining simple, smaller parts.

The illustrative embodiments provide mechanisms for dashboard creation with popular patterns and suggestions using analytics. Consider for a user interface, such as a Web-based administration console, that supports dashboard creation via a Web-based editor tool allowing the administrator to place widgets on dashboards and to configure the widgets to appropriate data sources and datasets. Using this interface, an administrator can create many different dashboards for clients. The administrator may create dashboards using the same widgets on different dashboards and using the same data source. In a usual case, the administrator may start from a plain canvas, drag-and-drop widgets, and configure them. Alternatively, the administrator may drag-and-drop pre-configured widgets.

In accordance with the illustrative embodiments, a dashboard creation mechanism is provided that uses analytics to analyze what kind of dashboards or views the administrator, or group of administrators, typically creates. Analytics is the discovery, interpretation, and communication of meaningful patterns in data. Especially valuable in areas rich with recorded information, analytics relies on the simultaneous application of statistics, computer programming, and operations research to quantify performance. Analytics often favors data visualization to communicate insight. Organizations may apply analytics to data to describe, predict, and improve performance. The dashboard creation mechanism discovers patterns in administrator data and user data to discover popular or new patterns and to predict dashboard configurations that are most likely to be useful for particular users or groups of users.

Some embodiments of the present invention may include one or more of the following features, characteristics, operations and/or advantages: (i) a method for use with dashboards that show computer operations and/or status; (ii) receiving first user dashboard preference data indicative of a first user's historical preferences for dashboard content, layout and/or customizability; (iii) receiving a new dashboard request indicative of need to design dashboard content and layout for a new dashboard for the first user, (iv) responsive to the new dashboard request, designing, by machine logic, a new dashboard data set corresponding to the new dashboard for the first user based, at least in part, upon the first user dashboard preference data; (v) the historical preferences for dashboard layout and content include preferences regarding the following: identify of widget(s), layout of widget(s) within the dashboard, data source(s), access level provided and way(s) in which end users may customize the dashboard; (vi) receiving historical dashboard design data indicative of designs of a plurality of existing dashboards with respect to dashboard content, layout and/or customizability; (vii) receiving a new dashboard request indicative of a need to design dashboard content and layout for a new dashboard; (viii) responsive to the new dashboard request, designing, by machine logic, a new dashboard data set corresponding to the new dashboard based, at least in part, upon the historical dashboard design data; and/or (ix) the historical dashboard design data includes, for each existing dashboard of the plurality of existing dashboards: identity of widget(s), layout of widget(s) within the dashboard, data source(s), access level provided and way(s) in which end users may customize the dashboard.

With respect to item (vi) in the list of the preceding paragraph, it should be understood that historical data may come from previous choices made by: (i) an individual user now designing a new dashboard (for example, a given user designs all his dashboards to represent length values in metric units, so his new dashboard will default to showing any length units in meters, millimeters, etc.); (ii) other users who belong to a common entity as a user designing a new dashboard (for example, Company A various dashboard designers invariably chose to display angular measurements at a granularity of a tenth of a radian, so the new dashboard defaults to this granularity with respect to dashboard displays of angular values); and/or (iii) other users from the public at large (for example, it is determined that most dashboard designers in the general public prefer to show fast operation speed in green, moderate operation speeds in yellow and slow operation speeds in red).

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

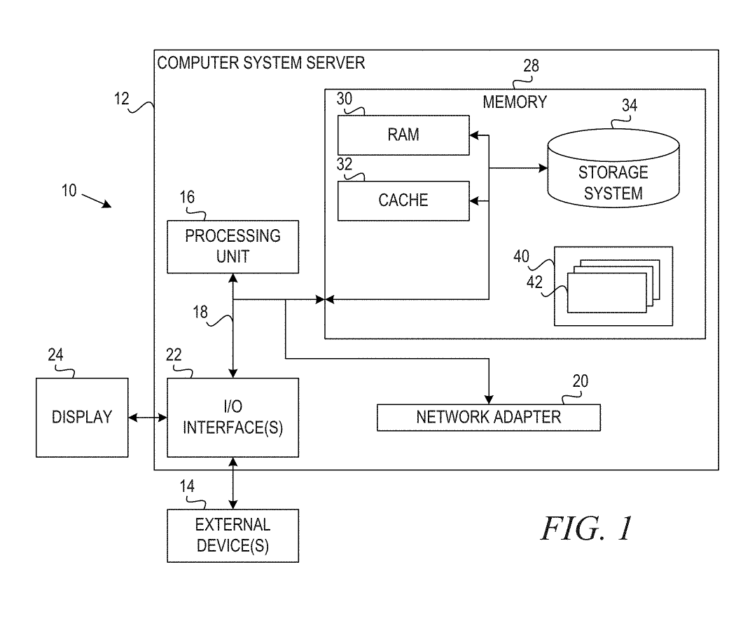

The illustrative embodiments may be utilized in many different types of data processing environments. In order to provide a context for the description of the specific elements and functionality of the illustrative embodiments, FIGS. 1-3 are provided hereafter as example environments in which aspects of the illustrative embodiments may be implemented. It should be appreciated that FIGS. 1-3 are only examples and are not intended to assert or imply any limitation with regard to the environments in which aspects or embodiments of the present invention may be implemented. Many modifications to the depicted environments may be made without departing from the spirit and scope of the present invention.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

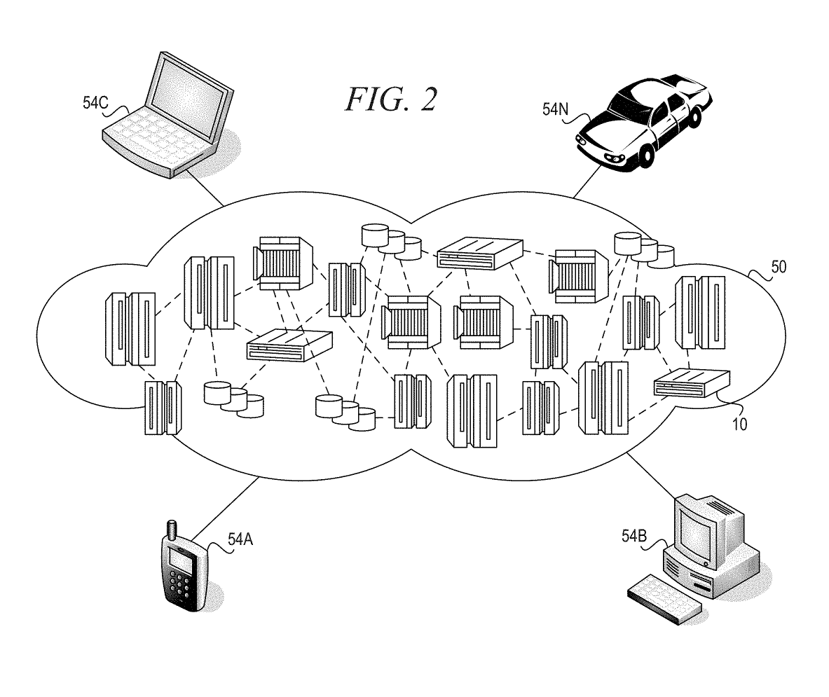

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

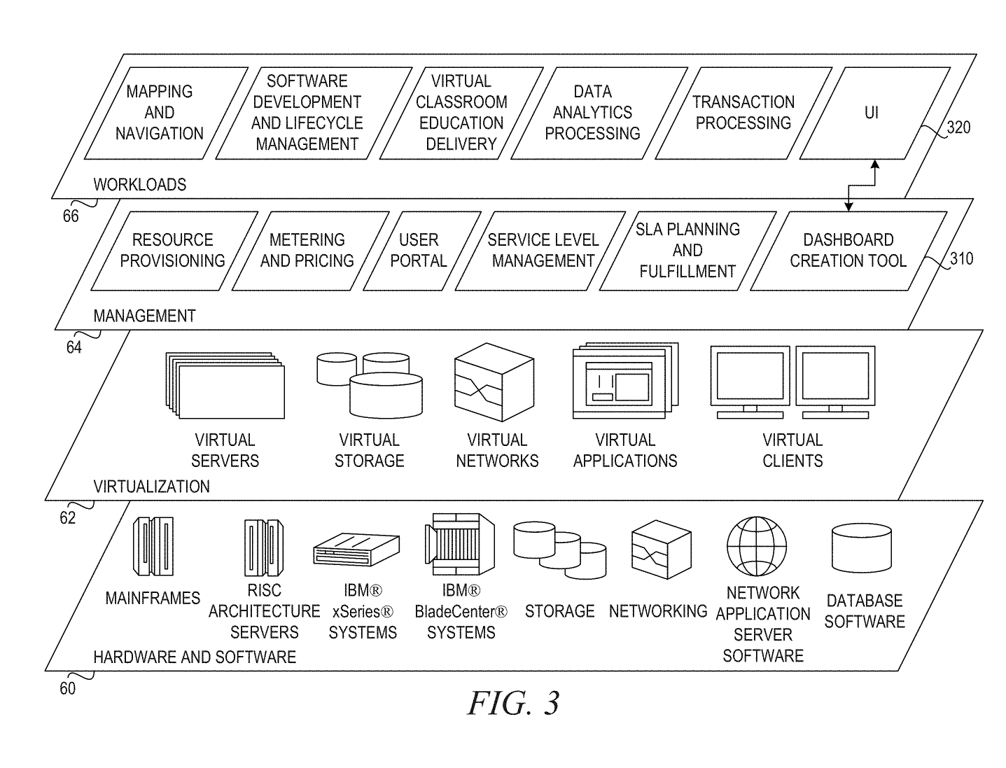

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation: software development and lifecycle management; virtual classroom education delivery: data analytics processing; and transaction processing.

In accordance with an illustrative embodiment, management layer 64 provides dashboard creation tool 310, which allows for dynamically generating a sandbox of dashboard patterns for an administrator with pre-configured layouts and widgets to help the administrator build new dashboards faster. Dashboard creation tool 310 also allows for suggestions for alternative widgets that can make the dashboards more informative. Further, dashboard creation tool 310 allows for a widget to appear in the catalog which has already been configured with a data source. For example, an administrator may frequently configure a generic bar chart to show population across countries. Dashboard creation tool 310 applies analytics to make the bar chart appear in the widget catalog already configured with the population data for future use.

Also, in accordance with an illustrative embodiment, workloads layer 66 provides a user interface (UI) 320 for interacting with dashboard creation tool 310. UI 320 may be a Web-based administration console, for example. In one example embodiment, UI 320 is a console through which end users interact with the dashboards created by the administrator. Therefore, using dashboard creation tool 310, an administrator creates pre-configured dashboards for end users to use in UI 320.

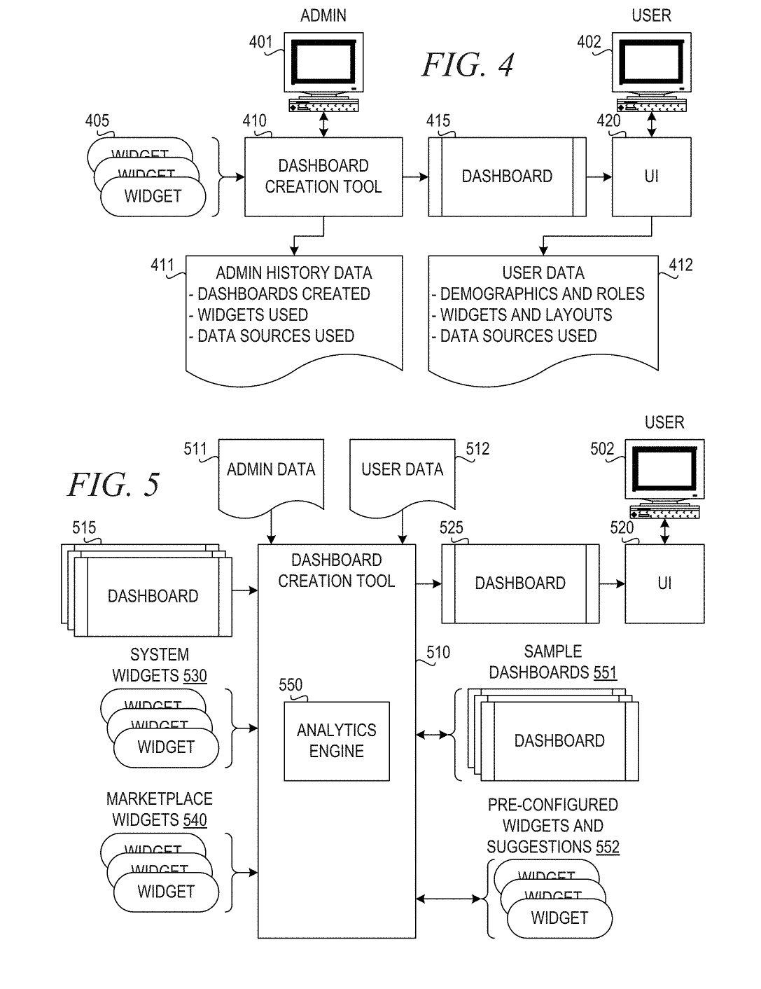

FIG. 4 is a block diagram of a dashboard creation tool in accordance with an illustrative embodiment. An administrator 401 uses dashboard creation tool 410 to create a dashboard 415 to be used by user 402 in user interface (UI) 420. Administrator 401 creates dashboard 415 by placing widgets 405 onto the dashboard 415 and configuring the layout. Dashboard 415 may be created as a base template or as a specific configuration for a given user. For example, dashboard 415 may serve as an administration console for a Web administrator. Thus, administrator 401 may select widgets from widgets 405 that are appropriate for viewing active visitors for geographic regions, visits by traffic type, bounces by territory, average visit duration, and the like. The administrator 401 may also configure the widgets 405 to use specific data sources or datasets.

In accordance with an illustrative embodiment, dashboard creation tool 410 records administrator history data 411, which may include dashboards usually created, widgets usually used, data sources used, and so forth. For example, administrator 401 may frequently configure a generic bar chart to show bounces by territory. This information will be evident in administrator history data 411.

In addition, user 402 accesses dashboard 415 through UI 420. User 402 may make changes to the dashboard by configuring the widgets, setting data sources, modifying the layout of the dashboard, etc. UI 420 may record user data 412 including, for example, user demographics and roles, widgets and layouts used, data sources used, and so forth. Each user may have a profile storing the demographic and role information, such as age, education, position within the organization, professional organizations, work team memberships, access level, etc.

FIG. 5 is a block diagram of a dashboard creation tool for creating dashboards with popular patterns and suggestions using analytics in accordance with an illustrative embodiment. The administrator uses dashboard creation tool 510 to create a dashboard 525 to be used by a user 502 in user interface 520. In accordance with the illustrative embodiment, dashboard creation tool 510 receives administrator data 511 and user data 512. Analytics engine 550 applies analytics to administrator data 511 and user data 512 to discover popular patterns of widgets, layouts, configurations, and data sources and to predict dashboard configurations that are most likely to be useful to specific users or groups of users.

Dashboard creation tool 510 selects from previous dashboard configurations 515 and system widgets 530 based on the results from analytics engine 550 to form sample dashboards 551 with pre-configured widgets and suggestions for alternatives 552. For example, the administrator may typically build dashboards using system widgets 530, while dashboard creation tool 510 may provide suggestions from marketplace widgets 540. The system widgets 530 and marketplace widgets 540 may have tags or descriptions that can be analyzed by analytics engine 550. This allows the administrator to consider widgets that are outside the usual system widgets 530. As another example, analytics engine 550 may discover that particular users or groups of users typically use specific data sources, widget configurations, or dashboard layouts; therefore, dashboard creation tool 510 may generate pre-configured widgets and suggestions 552. This allows the administrator to quickly build dashboard 525 for user 502 to access in UI 520 such that dashboard 525 is specifically tailored to how user 502 is likely to use such a dashboard.

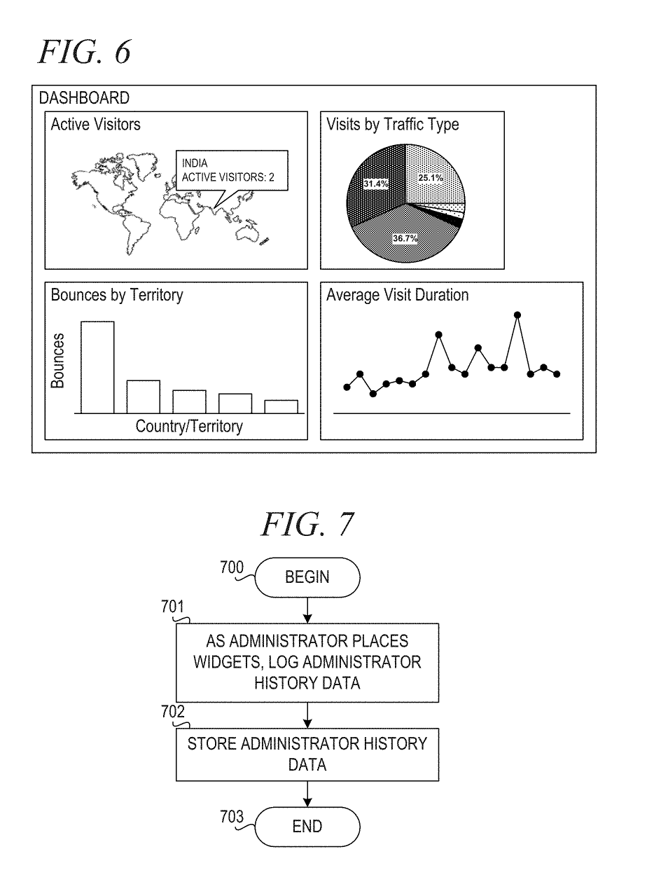

FIG. 6 depicts an example dashboard of widgets in accordance with an illustrative embodiment. As depicted in FIG. 6, the dashboard includes widgets including an active visitors widget showing active visitors by country on a map interface, a visits by traffic type widget that shows data using a pie chart, a bounces by territory widget that shows data in a bar chart, and an average visit duration widget that shows data in a line graph. A dashboard created using the mechanisms of the illustrative embodiments can include any available widget type with various data sources or datasets and configured in particular was. In addition, such a dashboard may have a specific layout based on how particular users or groups of users typically configure the dashboard.

As an example scenario, an administrator builds several dashboards. The dashboard creation tool analyzes the widgets and the dashboard used by the administrator. The dashboard creation tool places a dashboard pattern in the administrator's dashboard creation console. The administrator can then start with this dashboard pattern the next time the administrator builds a new dashboard. If the administrator builds another dashboard with the same basic layout and widgets, then a new pattern is not created since it is similar to the existing pattern. However, if the administrator builds a very different dashboard, then the dashboard creation tool may create a new dashboard pattern in addition to the previous pattern.

As another example scenario, an administrator builds a dashboard using the available widgets in the system. The administrator installs new widgets into the system. The dashboard creation tool analyzes the new widgets against the widgets in a dashboard pattern. The next time the administrator creates a dashboard with the pattern, the dashboard creation tool will suggest possible alternative visualizations based on the widgets the administrator has used and the new widgets. For example, the dashboard creation tool may suggest a topology view instead of a tree view.

As yet another example scenario, an administrator builds a dashboard using the available widgets in the system. The dashboard creation tool analyzes widgets available in the marketplace against widgets the administrator has in the dashboard pattern. The next time the administrator creates a dashboard with the pattern, the dashboard creation tool may suggest possible alternative visualizations based on the widgets the administrator has used and the marketplace widgets.

As another example scenario, an administrator selects a data source from available data sources in the system. The dashboard creation tool analyzes the data source and based on the type of data provides a suggestion of different widgets and dashboard layouts is provided based on previously used widgets and layouts with similar data.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

FIG. 7 is a flowchart illustrating operation of a dashboard creation tool in accordance with an illustrative embodiment. Operation begins (block 700), and an administrator uses the dashboard creation tool to create a dashboard to be used by a user in a user interface (UI). The administrator creates the dashboard by placing widgets onto the dashboard and configuring the layout. As the administrator places the widgets and creates the dashboard, the dashboard creation tool logs administrator history data (block 701). The administrator history data may include dashboards usually created, widgets usually used, data sources used, and so forth. The dashboard creation tool stores the administrator history data (block 702) to be used by an analytics engine in later dashboard creation. Thereafter, operation ends (block 703).

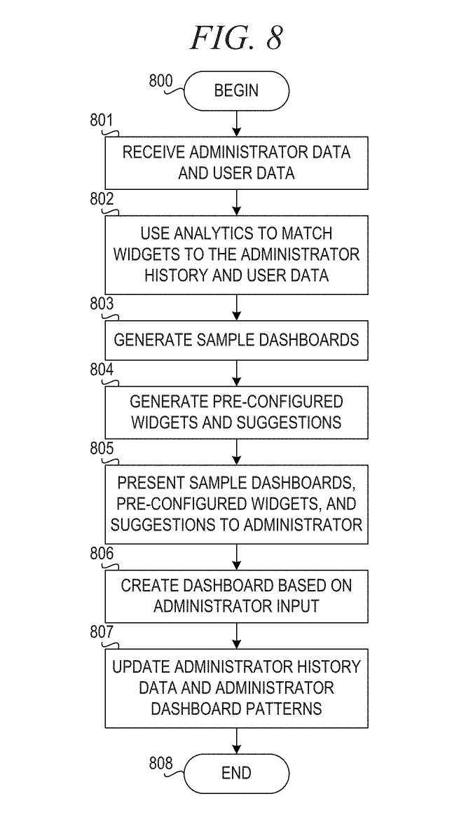

FIG. 8 is a flowchart illustrating a dashboard creation tool for creating dashboards with popular patterns and suggestions using analytics in accordance with an illustrative embodiment. Operation begins (block 800), and the dashboard creation tool receives administrator history data and user data (block 801). The dashboard creation tool applies analytics to the administrator history data and the user data to discover popular patterns of widgets, layouts, configurations, and data sources and to predict dashboard configurations that are most likely to be useful to specific users or groups of users (block 802).

The dashboard creation tool selects from previous dashboard configurations and system widgets based on the results from analytics to generate sample dashboards (block 803). The dashboard creation tool also generates pre-configured widgets and suggestions for alternatives such as new or enhanced widgets (block 804). The dashboard creation tool then presents the sample dashboards, pre-configured widgets, and suggestions to the administrator (block 805). The dashboard creation tool creates a dashboard for a user or group of users based on administrator input (block 806). The dashboard creation tool updates the administrator history data and administrator dashboard patterns (block 807). Thereafter, operation ends (block 808).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for use with dashboards that show computer operations and/or status comprising:
receiving first user dashboard preference data indicative of a first user's historical preferences for dashboard content, layout and/or customizability;
receiving a new dashboard request indicative of a need to design dashboard content and layout for a new dashboard for the first user; and
responsive to the new dashboard request, designing, by machine logic, a new dashboard data set corresponding to the new dashboard for the first user based, at least in part, upon the first user dashboard preference data.

2. The method of claim 1, wherein the historical preferences for dashboard layout and content include preferences regarding the following: identity of widget(s), layout of widget(s) within the dashboard, data source(s), access level provided and way(s) in which end users may customize the dashboard.

3. A method for use with dashboards that show computer operations and/or status comprising:
receiving historical dashboard design data indicative of designs of a plurality of existing dashboards with respect to dashboard content, layout and/or customizability;
receiving a new dashboard request indicative of a need to design dashboard content and layout for a new dashboard; and
responsive to the new dashboard request, designing, by machine logic, a new dashboard data set corresponding to the new dashboard based, at least in part, upon the historical dashboard design data.

4. The method of claim 3, wherein the historical dashboard design data includes, for each existing dashboard of the plurality of existing dashboards: identity of widget(s), layout of widget(s) within the dashboard, data source(s), access level provided and way(s) in which end users may customize the dashboard.

5. The method of claim 1, further comprising:
receiving, by a dashboard creation tool executing on at least one processor of a data processing system, administrator history data for an administrator; and
applying, by an analytics engine executing within the data processing system, analytics to the administrator history data, the first user dashboard preference data, a set of dashboard patterns associated with the administrator, and a set of widgets available for dashboard creation to discover patterns of dashboard creation by the administrator and patterns of dashboard configuration by the plurality of users.

6. The method of claim 5, wherein designing the new dashboard data set comprises:
generating, by the dashboard creation tool, a set of sample dashboards based on results from the analytics engine; and
presenting, by the dashboard creation tool, the set of sample dashboards to the administrator.

7. The method of claim 5, further comprising creating a dashboard of widgets for the first user based on the set of sample dashboards and inputs from the administrator.

8. The method of claim 7, further comprising presenting the dashboard of widgets to the first user in a user interface in a cloud environment.

9. The method of claim 5, wherein the administrator history data comprises at least one of dashboards created by the administrator, widgets used by the administrator, or data sources used by the administrator to create dashboards.

10. The method of claim 1, wherein the first user dashboard preference data comprises at least one of demographics and roles, widgets used, layouts used, or data sources used.

11. The method of claim 5, further comprising generating a set of pre-configured widgets and suggested alternative widgets based on results from the analytics engine and presenting the set of pre-configured widgets and suggested alternative widgets to the administrator.

12. The method of claim 5, further comprising generating, by the dashboard creation tool, a set of dashboard templates based on the discovered patterns of dashboard creation.

13. The method of claim 5, wherein presenting the set of sample dashboards to the administrator comprises presenting the set of sample dashboards in an administrator console.

14. The method of claim 13, wherein the administrator accesses the administrator console in a cloud computing environment.

15. A computer program product comprising a computer readable storage medium having a computer readable program stored therein, wherein the computer readable program, when executed on at least one processor of a data processing system, causes the computing device to implement dashboard creation tool, wherein the computer readable program causes the data processing system to:
receive first user dashboard preference data indicative of a first user's historical preferences for dashboard content, layout and/or customizability;
receive a new dashboard request indicative of a need to design dashboard content and layout for a new dashboard for the first user; and
responsive to the new dashboard request, design, by machine logic, a new dashboard data set corresponding to the new dashboard for the first user based, at least in part, upon the first user dashboard preference data.

16. The computer program product of claim 15, wherein the historical preferences for dashboard layout and content include preferences regarding the following: identity of widget(s), layout of widget(s) within the dashboard, data source(s), access level provided and way(s) in which end users may customize the dashboard.

17. The computer program product of claim 15, wherein the computer readable program further causes the data processing system to:
receive, by a dashboard creation tool executing on at least one processor of a data processing system, administrator history data for an administrator; and
apply, by an analytics engine executing within the data processing system, analytics to the administrator history data, the first user dashboard preference data, a set of dashboard patterns associated with the administrator, and a set of widgets available for dashboard creation to discover patterns of dashboard creation by the administrator and patterns of dashboard configuration by the plurality of users.

18. The computer program product of claim 17, wherein the computer readable program further causes the data processing system to create a dashboard of widgets for the first user based on the set of sample dashboards and inputs from the administrator.

19. The computer program product of claim 17, wherein the computer readable program further causes the data processing system to generate a set of pre-configured widgets and suggested alternative widgets based on results from the analytics engine and presenting the set of pre-configured widgets and suggested alternative widgets to the administrator.

20. A data processing system comprising:
a processor; and
a memory coupled to the processor, wherein the memory comprises instructions which, when executed by the processor, cause the processor to implement dashboard creation tool, wherein the instructions cause the processor to:
receive first user dashboard preference data indicative of a first user's historical preferences for dashboard content, layout and/or customizability;
receive a new dashboard request indicative of a need to design dashboard content and layout for a new dashboard for the first user; and
responsive to the new dashboard request, design, by machine logic, a new dashboard data set corresponding to the new dashboard for the first user based, at least in part, upon the first user dashboard preference data.
